(19) United States
(12) Patent Application Publication
(10) Pub. No.: US 2025/0125626 A1
(43) Pub. Date: Apr. 17, 2025

(54) Serially Connected Inverters

(71) Applicant: Solaredge Technologies Ltd., Herzeliya (IL)

(72) Inventors: Ilan Yoscovich, Givatayim (IL); Meir Gazit, Rosh Ha'ayin (IL); Tzachi Glovinsky, Petah Tikva (IL); Yoav Galin, Raanana (IL)

(21) Appl. No.: 19/001,998

(22) Filed: Dec. 26, 2024

Related U.S. Application Data
(63) Continuation of application No. 17/528,409, filed on Nov. 17, 2021, now Pat. No. 12,218,505.
Application No. 17/528,409 is a continuation of application No. 16/709,356, filed on Dec. 10, 2019, now Pat. No. 11,205,946.
Application No. 16/709,356 is a continuation of application No. 15/823,970, filed on Nov. 28, 2017, now Pat. No. 10,666,125.
Application No. 15/823,970 is a continuation of application No. 14/303,067, filed on Jun. 12, 2014, now Pat. No. 9,866,098.
Application No. 14/303,067 is a continuation of application No. 13/348,214, filed on Jan. 11, 2012, now abandoned.

(30) Foreign Application Priority Data
Jan. 12, 2021 (GB) 1100450.4

(51) Int. Cl. H02J 3/38; H02J 3/00; H02J 3/42; H02J 3/46; H02M 1/00; H02M 1/32; H02M 7/49

(52) U.S. Cl. CPC H02J 3/381; H02J 3/00; H02J 3/38; H02J 3/388; H02J 3/42; H02J 3/46; H02M 7/49; H02J 2300/24; H02J 2300/26; H02M 1/0077; H02M 1/325; Y02E 10/56

(57) ABSTRACT

A photovoltaic power generation system, having a photovoltaic panel, which has a direct current (DC) output and a micro-inverter with input terminals and output terminals. The input terminals are adapted for connection to the DC output. The micro-inverter is configured for converting an input DC power received at the input terminals to an output alternating current (AC) power at the output terminals. A bypass current path between the output terminals may be adapted for passing current produced externally to the micro-inverter. The micro-inverter is configured to output an alternating current voltage significantly less than a grid voltage.

### CROSS REFERENCE TO RELATED APPLICATIONS

The present application is a continuation of U.S. patent application Ser. No. 17/528,409, filed Nov. 17, 2021, which is a continuation of U.S. patent application Ser. No. 16/709,356, filed Dec. 10, 2019 (issued as U.S. Pat. No. 11,205,946), which is a continuation of U.S. patent application Ser. No. 15/823,970, filed Nov. 28, 2017 (issued as U.S. Pat. No. 10,666,125), which is a continuation of U.S. patent application Ser. No. 14/303,067, filed Jun. 12, 2014 (issued as U.S. Pat. No. 9,866,098), which is a continuation of U.S. patent application Ser. No. 13/348,214, filed Jan. 11, 2012, which claims priority to patent application GB1100450.4, filed Jan. 12, 2011 in the United Kingdom Intellectual Property Office, all of which are herein incorporated by reference as to their entireties and for all purposes.

### FIELD OF THE INVENTION

Aspects generally relate to distributed power system and more particularly to the use of multiple micro-inverters.

### BACKGROUND

Recent increased interest in renewable energy has led to research and development of distributed power generation systems including photovoltaic cells and fuel cells. Various topologies have been proposed for connecting these power sources to the load, taking into consideration various parameters, such as voltage/current requirements, operating conditions, reliability, safety, costs. These sources provide low voltage direct current output (normally below 3 Volts), so they are connected serially to achieve the required voltage. Conversely, a serial connection may fail to provide the required current, so that several strings of serial connections may be connected in parallel to provide the required current.

Power generation from each of these sources typically depends on manufacturing, operating, and environmental conditions of the power sources, e.g. photovoltaic panels. For example, various inconsistencies in manufacturing may cause two identical sources to provide different output characteristics. Similarly, two identical sources may react differently to operating and/or environmental conditions, such as load, temperature, etc. In practical installations, different source may also experience different environmental conditions, e.g. in solar power installations some panels may be exposed to full sun, while others be shaded, thereby delivering different power output.

Islanding is a condition where a power generation system is severed from the utility network, but continues to supply power to portions of the utility network after the utility power supply is disconnected from those portions of the network. Photovoltaic systems must have anti-islanding detection in order to comply with safety regulations. Otherwise, the photovoltaic installation may electrically shock or electrocute repairpersons after the grid is shut down from the photovoltaic installation generating power as an island downstream. The island condition poses a hazard also to equipment. Thus, it is important for an island condition to be detected and eliminated.

The process of connecting an alternating current (AC) generator or power source (e.g. alternator, inverter) to other AC power sources or the power grid is known as synchronization and is crucial for the generation of AC electrical power. There are five conditions that are met for the synchronization process. The power source must have equal line voltage, frequency, phase sequence, phase angle, and waveform to that of the power grid. Typically, synchronization is performed and controlled with the aid of synch relays and micro-electronic systems.

The term “grid voltage” as used herein is the voltage of the electrical power grid usually 110V or 220V at 60 Hz or 220V at 50 Hz.

### BRIEF SUMMARY

According to various aspects there is provided a micro-inverter having input terminals and output terminals. The micro-inverter may be adapted for inverting an input DC power received at the input terminals to an output alternating current (AC) power at the output terminals, which have a voltage significantly less than a grid voltage. A bypass current path between the output terminals may be adapted for passing current produced externally to the micro-inverter. An optional synchronization module may be adapted for synchronizing the output AC power to the grid voltage. A control loop may be configured to set the input DC power received at the input terminals according to a previously determined criterion. The previously determined criterion typically sets a maximum input power.

According to various aspects there is provided a photovoltaic power generation system having multiple photovoltaic panels with direct current (DC) outputs connectible to multiple micro-inverters. Each micro-inverter has input terminals connectible to the DC outputs and output terminals. The micro-inverters are configured for inverting input DC power received at the input terminals to an output alternating current (AC) at the output terminals with an output voltage substantially less than a grid voltage. The output terminals are connectible in series into a serial string and an output voltage of the serial string may be substantially equal to the grid voltage. Each micro-inverter includes a bypass current path between the output terminals for passing current produced externally in the serial string. The alternating current (AC) micro-inverter may have a control loop configured to set the input DC power received at the input terminals according to a previously determined criterion. An optional central control unit may be operatively attached to the serial string and the grid voltage. The central control unit may be adapted for disconnecting the system from the grid upon detecting a less than minimal grid voltage. The central control unit optionally monitors the synchronization of the voltage of the serial string to the grid voltage and disconnects the serially connected micro-inverters from the grid or disables the micro-inverters upon a lack of synchronization between the grid voltage and the output voltage of the serially connected micro-inverters.

According to various aspects there is provided a method for photovoltaic power generation in a system having multiple of photovoltaic panels with direct current (DC) outputs and multiple micro-inverters each including input terminals and output terminals. The input terminals of the micro-inverters are connectible to respective DC outputs of the photovoltaic panels. The output terminals are connected serially to a serial voltage output. The DC power received at the input terminals may be inverted to an output alternating current (AC) power at the output terminals while maintaining the serial voltage output substantially equal to a grid voltage. The output terminals preferably have a current bypass in the event of failure of inverting the DC power received at the input terminals to the output alternating current (AC) power at the output terminals or upon the micro-inverter being shut down in the event of a failure to maintain the serial voltage output at the level of the grid voltage.

Upon connecting the input terminals and the output terminals, inversion of input DC power to output power may be enabled after a previously determined time delay. The serial voltage output may be synchronized to the grid voltage. The output terminals preferably have a current bypass in the event of failure of inverting the DC power received at the input terminals to the output alternating current (AC) power at the output terminals or upon the micro-inverter being shut down in the event of a failure to maintain the serial voltage output at the level of the grid voltage.

### BRIEF DESCRIPTION OF THE DRAWINGS

Various embodiments are described, by way of example only, with reference to the accompanying drawings, wherein:

FIG. 1 shows a conventional installation of a solar power system.

FIG. 2 illustrates one serial string of DC sources.

FIG. 3 illustrates a power harvesting system.

FIG. 4a illustrates a power harvesting system in accordance with one or more embodiments of the disclosure.

FIG. 4b illustrates a power harvesting system in accordance with one or more embodiments of the disclosure.

FIG. 4c illustrates further details of a bypass in accordance with one or more embodiments of the disclosure.

FIG. 5a illustrates a method of operation of a power harvesting system in accordance with one or more embodiments of the disclosure.

FIG. 5b shows further details of connection and wake-up of a power harvesting system in accordance with one or more embodiments of the disclosure.

FIG. 5c shows further details of operation in accordance with one or more embodiments of the disclosure.

The foregoing and/or other aspects will become apparent from the following detailed description when considered in conjunction with the accompanying drawing figures.

### DETAILED DESCRIPTION

Reference will now be made in detail to various embodiments, examples of which are illustrated in the accompanying drawings, wherein like reference numerals refer to the like elements throughout. Various aspects are described below with reference to the figures.

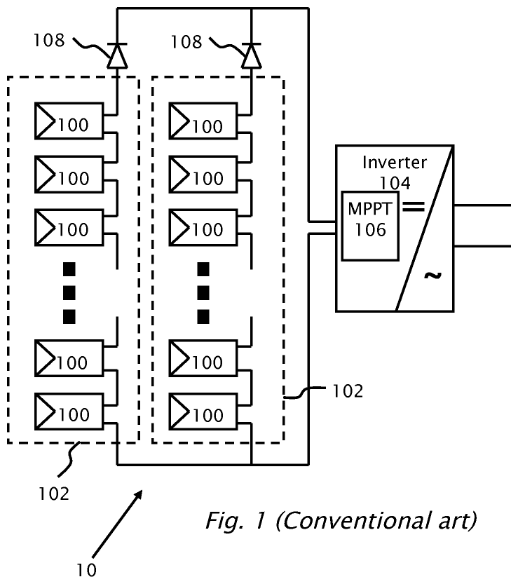

A conventional installation of a solar power system 10 is illustrated in FIG. 1. Since the voltage provided by each individual photovoltaic panel 100 is low, several panels 100 are connected in series to form a string 102 of panels 100. For a large installation, in order to achieve higher current, several strings 102 may be connected in parallel. Photovoltaic panels 100 are mounted outdoors, and are connected to a maximum power point tracking (MPPT) module 106 and to an inverter 104. MPPT 106 is typically implemented in the same housing as inverter 104.

Harvested power from the DC sources is delivered to inverter 104, which converts the fluctuating direct-current (DC) into alternating-current (AC) having a desired voltage and frequency, which, for residential application, is usually 110V or 220V at 60 Hz or 220V at 50 Hz. AC current from inverter 104 may then be used for operating electric appliances or fed to the power grid. Alternatively, if the installation is not tied to the grid, the power extracted from inverter 104 may be directed to store the excess power in batteries.

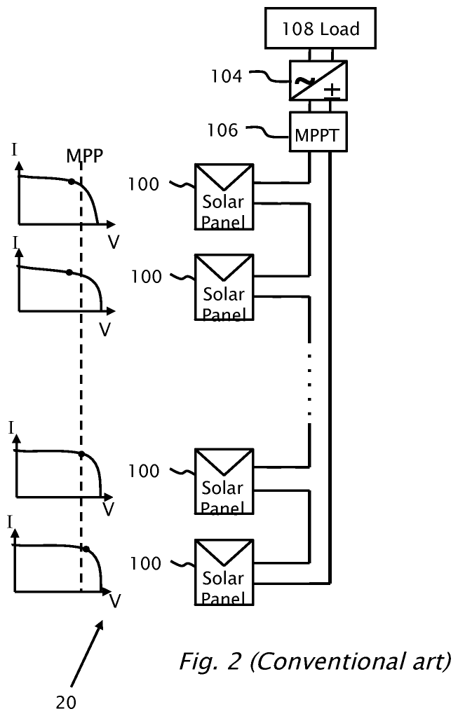

FIG. 2 illustrates one serial string of DC sources according to conventional art, photovoltaic panels 100, connected to MPPT circuit 106 and inverter 104 to form a power harvesting system 20 connected to load 108. The current versus voltage (IV) characteristics are plotted to the left of each photovoltaic panel 100. For each photovoltaic panel 100, the current decreases as the output voltage increases. At some voltage value the current goes to zero, and in some applications may assume a negative value, meaning that some photovoltaic panels 100 instead of being sources of power become sinks of power. Bypass diodes (not shown) connected in parallel across each photovoltaic panel 100 output are used to prevent any photovoltaic panel 100 from becoming a sink of power. The power output of each photovoltaic panel 100 is equal to the product of current and voltage (P=I*V) and varies depending on the voltage drawn from the panel 100. At a certain current and voltage, the power reaches its maximum (represented by the dot on the IV curve for each graph). It is desirable to operate a panel 100 at this maximum power point (MPP). The purpose of the maximum power point tracking (MPPT) module 106 is to find a suitable “average” maximum power point (MPP) for all panels 100. The maximum power point of the string selected by MPPT module 106 is shown using a dotted line with label MPP. The maximum power point of the string of panels 100 is generally not the maximum power of all panels 100. The dots indicating maximum power point of the individual panels 100 do not fall on the dotted line marked MPP.

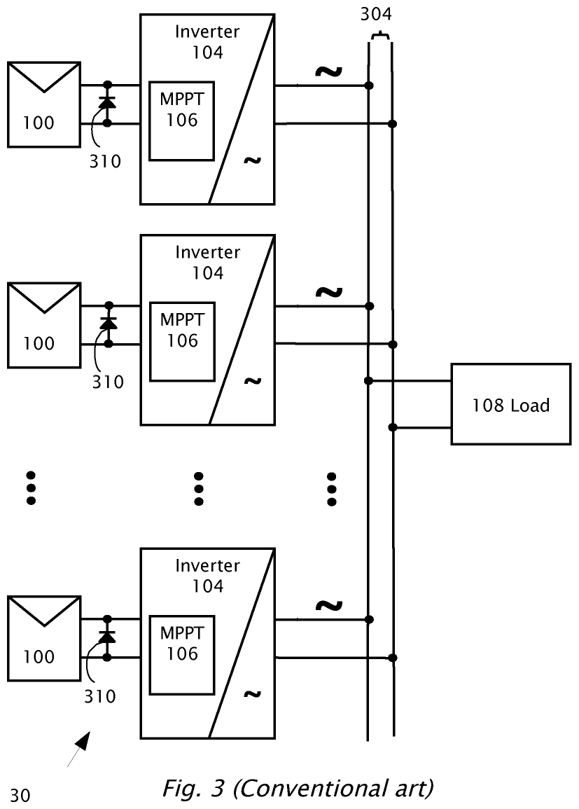

FIG. 3 illustrates another power harvesting system 30 according to conventional art, which combines power of multiple photovoltaic panels 100. Each photovoltaic panel 100 has a direct current (DC) output connected to the input of an inverter 104. A bypass diode 310 is connected in parallel across the direct current (DC) output panel 100 for safety requirements. Inverter 104 receives the direct current (DC) output of photovoltaic panel 100 and converts the direct current (DC) to give an alternating current (AC) at the output of inverter 104. Maximum power point tracking (MPPT) module 106 is typically implemented as part of the inverter 104. The outputs of multiple inverters 104 (with inputs attached to multiple photovoltaic panels 100) are connected in parallel to produce an alternating current (AC) output 304. Alternating current (AC) output 304 supplies load 108. Load 108 typically is an alternating current (AC) power grid, alternating current (AC) motor or a battery charging circuit.

Before explaining various aspects in detail, it is to be understood that embodiments are not limited to the details of design and the arrangement of the components set forth in the following description and illustrated in the drawings. Other embodiments are capable of being practiced and carried out in various ways. Also, it is to be understood that the phraseology and terminology employed herein is for the purpose of description and should not be regarded as limiting.

By way of introduction, aspects are directed to serially connected inverters in a grid connected photovoltaic system. In a system with serially connected inverters, as opposed to conventional system 30 which illustrates parallel connected inverters, each inverter is required to output a low voltage, for instance 24 volts AC root mean square (RMS) for ten serially connected inverters. Low output voltage of the micro-inverter is suitable for efficient and low cost micro-inverter topologies. One such topology is discussed in IEEE Transactions on Power Electronics, Vol. 22, No. 5, September 2007, entitled “A Single-Stage Grid Connected Inverter Topology for Solar PV Systems With Maximum Power Point Tracking, this paper proposes a high performance, single-stage inverter topology for grid connected PV systems.

The term “bypass” as used herein refers to an alternate low impedance current path around or through a circuit, equipment or a system component. The bypass is used to continue operation when the bypassed circuit is inoperable or unavailable.

The terms “wake-up” and “shut-down” as used herein refer to processes during, which a photovoltaic system is activated or de-activated respectively. A criterion for “wake-up”, i.e. activation of a photovoltaic panel, for instance, is that a photovoltaic panel is exposed to sufficient light such as at dawn A criterion for “shut-down”, i.e. de-activation of a photovoltaic panel, is that a photovoltaic panel is not exposed to sufficient light, for example at dusk.

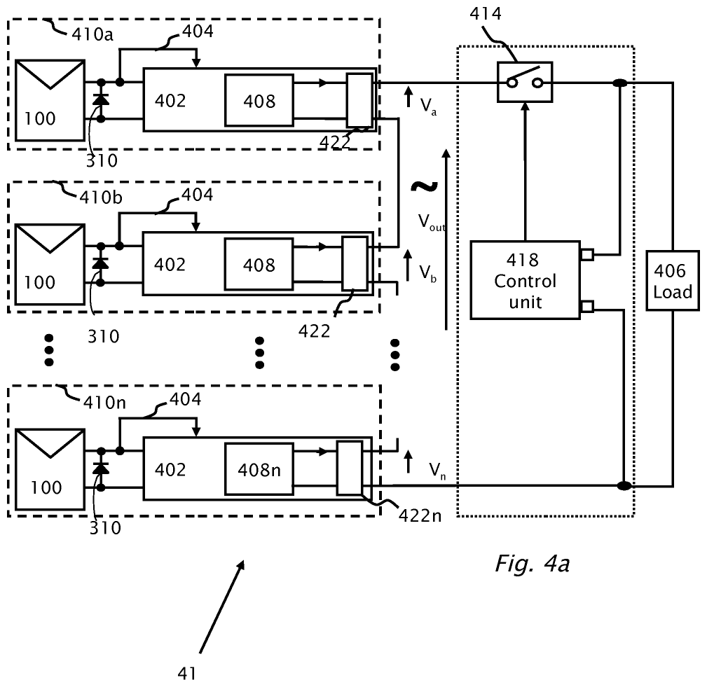

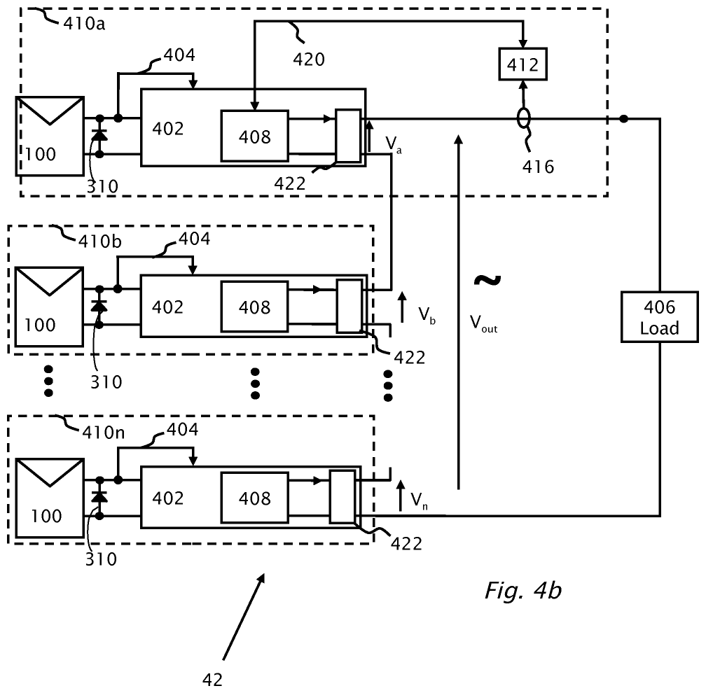

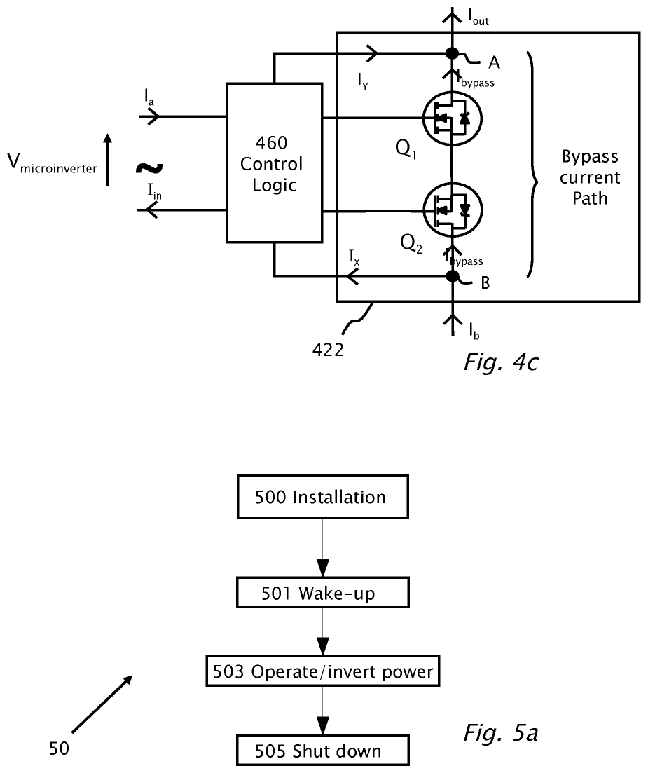

Reference is now made to FIG. 4a, which illustrates a power harvesting system 41 according to some embodiments. Photovoltaic inverting modules 410 each have panel 100, bypass diode 310, a control loop 404 and micro-inverter 402. Micro-inverters 402 may have optional synchronization units 408 and current bypass paths 422. Photovoltaic panels 100 have direct current (DC) outputs, which are connected respectively to the input of inverters 402. Bypass diodes 310 may connected in parallel across the direct current (DC) outputs of each panel 100 for safety requirements (e.g. IEC61730-2 solar safety standards). Control loops 404 are configured according to a predetermined criterion, typically to maintain maximum power at the inputs of micro-inverters 402, i.e. from the direct current (DC) outputs of photovoltaic panels 100. Bypass paths 422 are optionally normally-closed relays, which open during operation, and which are connected respectively to the outputs of photovoltaic inverting modules 410. Photovoltaic inverting modules 410 have alternating current (AC) outputs with voltage Vₐ and current Iₐ from module 410a; voltage V_{b} and current I_{b} from module 410b; voltage Vₙ and current Iₙ from module 410n. Outputs of modules 410 are connected in series to give a voltage output Vₒᵤₜ, which is applied to a load 406 via switch 414. Switch 414 is preferably controlled by control unit 418. Load 406 typically is an alternating current (AC) power grid, alternating current (AC) motor or a battery charging circuit. Control units 408 typically provide control signals to synchronization units 408 in order to achieve synchronization with load or grid 406. Synchronization units 408 or control unit 418 provide anti-islanding functionality for power harvesting system 41.

Additionally, the outputs of photovoltaic inverting modules 410a-410n are bypassed (i.e. the output of modules 410a-410n are short circuited) by bypass 422 in the event of under voltage production by micro inverter modules 402 or the bypass is opened (i.e. modules 410a-410n are open circuit) in the event of over voltage by micro inverter modules 402 or during a situation of anti-islanding.

Reference is now made to FIG. 4c, which illustrates further details of bypass 422 according to various embodiments. Bypass 422 is controlled by control logic module 460, e.g. a microprocessor 460 controlling micro-inverter 402. Microprocessor 460 has a sensing input connected to the output voltage (V_{microinverter}) of micro inverter 402. Control logic module 460 has other inputs connected across the bypass path at nodes A and B. Control logic module 460 has two outputs; one output connects to the gate of a metal oxide semi-conductor field effect transistor (MOSFET) Q₁, the other output connects to the gate of MOSFET Q₂. The drain of MOSFET Q₁ is connected to node A and the source of MOSFET Q₁ is connected to the source of MOSFET Q₂, the drain of MOSFET Q₂ is connected to node B. MOSFET Q₁ has a diode with an anode connected to the drain and a cathode connected to the source. MOSFET Q₂ has a diode with an anode connected to the drain and a cathode connected to the source. The bypass current (I_{bypass}) path is identified between nodes A and B.

A high impedance path is provided between nodes A and B when micro inverter 402 is producing an alternating current (AC) voltage synchronized to grid voltage 406. The high impedance path is provided between nodes A and B when MOSFETs Q₁ and Q₂ are turned off by control logic unit 460. When the high impedance path is provided between nodes A and B currents I_{b}, I_{X}, Iᵢₙ, Iₐ, I_{Y} and Iₒᵤₜ are equal according to Kirchhoff's current law. A low impedance path is provided between nodes A and B when micro inverter 402 is not producing an AC voltage and another serially-connected micro inverter 402 is producing an AC voltage. A low impedance path is provided between nodes A and B by alternately switching MOSFETs Q₁ and Q₂ on and off alternately via control logic unit 406. When the load 406 is a grid voltage Q₁ and Q₂ are turned alternately on and off according to the frequency of the grid voltage. When the load 406 is a load, Q₁ and Q₂ are turned alternately on and off according to the frequency of synchronized inverters 402a-402n. In the case of low impedance path being provided between nodes A and B in the embodiment according to FIG. 4a; switching MOSFETs Q₁ and Q₂ on and off by control logic unit 460 is achieved via communication signals between central control unit 408 and control units 408a-408n. In the case of low impedance path being provided between nodes A and B in the embodiment according to FIG. 4b; switching MOSFETs Q₁ and Q₂ on and off alternately by control logic unit 460 is achieved via communication signals between control units 408a-408n and information of grid voltage 406 via sensor 416. A low impedance path provided between nodes A and B means that currents I_{b}, I_{bypass} and Iₒᵤₜ are substantially equal according to Kirchhoff's current law. A low impedance path provided between nodes A and B means that current I_{bypass} flows alternately from drain to source of Q₂ and the diode of Q₁ for one half cycle and for the other half cycle I_{bypass} flows alternately through from drain to source of Q₁ and the diode of Q₂.

Reference is now made to FIG. 4b, which illustrates a power harvesting system 42 according to further embodiments. As in power harvesting system 41 photovoltaic inverting modules 410a-410n each has a photovoltaic panel 100, bypass diode 310, control loops 404 and inverters 402 having synchronization units 408 and current bypasses 422. Modules 410a-410n have outputs connected in series to give a voltage output Vₒᵤₜ, which is applied to load 406. Sensor 416 preferably senses the live voltage applied to load 406 optionally via electromagnetic pickup on the power line connected to load 406 or directly by having visibility of the grid by virtue of bypasses 422. Sensor unit 412 transfers details of the load voltage (e.g. amplitude, phase, and frequency) to synchronization unit 408a via control line 420. Control signals are optionally sent over power line communications, wireless or over a separate interface.

Although only one control line 420 is shown, optionally multiple or all synchronization units 422 receive synchronization signals from sensor 412.

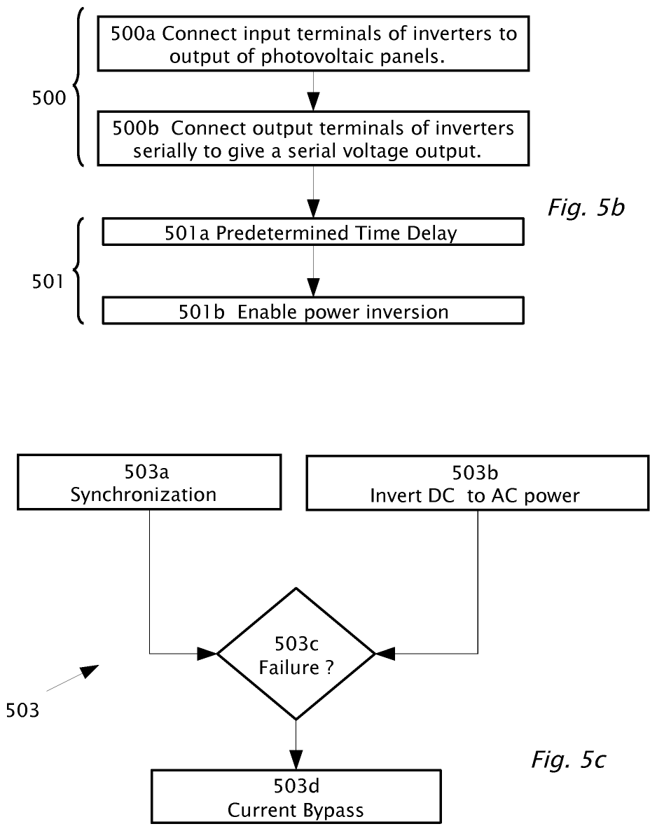

Reference is now made to FIG. 5a, which shows a flow chart of a method 50 illustrating operation of power harvesting systems 41 and 42 according to various aspects. Method steps include installation (step 500) wake-up (step 501), normal operation (step 503), and shut down (step 505).

### 500 Installation and 501 Wake-Up

During installation (step 500), photovoltaic modules 410 are preferably not producing power so as not to be a safety hazard to the installers. Optionally, a “keep-alive” signal is transmitted for instance by control unit 418 over the AC power lines. When the “keep-alive” signal is not received by micro-inverters 402, AC output power is disabled or not produced. Alternatively, if the grid is “visible” to micro-inverters 402, then in the absence of grid voltage, (e.g. switch 414 in FIG. 4a is open) micro-inverters 402 do not produce AC power. Reference is now made to FIG. 5b, which illustrates an installation method 500 according to certain aspects. In step 500a, input terminals of micro-inverters 402 are connected to the output of photovoltaic panels 100. In step 500b, the output terminals of photovoltaic panels 100 are connected serially to give a serial voltage output. After an optional predetermined time delay (step 501a), power inversion is enabled (step 501b). The enabling (step 501b) of power inversion may be performed by synchronization modules 408 when grid voltage is sensed or by control unit 418 when switch 414 is closed.

### 503 Operation and 505 Shutdown

Reference is now made again to FIG. 5c, which shows a flow chart of a method 503 for operating serially connected micro-inverter module according to various embodiments. Micro-inverters 402 invert (step 503b) the direct current (DC) power output of photovoltaic panels 100 to alternating current (AC) power at the outputs of micro-inverters 402 while maintaining output voltage equal to the grid voltage. Synchronization (step 503a) between the voltage outputs of micro-inverters 402a-402n and the grid voltage is maintained. Control unit 418 optionally monitors AC synchronization between output voltage Vₒᵤₜ and load 406, e.g. grid. Control unit 418 also may provide anti-islanding functionality for power harvesting system 41. If either synchronization and/or voltage of power harvesting system 41 is incompatible with the grid, control unit 418 disconnects power harvesting system from the grid by signaling switch 414. Alternatively, synchronization (step 503a) including maintenance of grid voltage is achieved using synchronization units 422 which can sense the grid by virtue of bypass paths 422. Upon failure of either synchronization (step 503a) or inverting power at grid voltage (step 503b) by any of the serially connected micro-inverter modules 402, then current bypass occurs (step 503d). Current bypass is optionally an active current bypass using active switches as shown in FIG. 4c or preferably a passive current bypass. Shutdown (step 505) occurs for instance at dusk when light levels are two low to maintain the grid voltage at any current level. During shutdown, the photovoltaic system is optionally disconnected from the grid using switch 414 in system 41 or in system 42 each of micro inverter modules 402 stop and present high impedance to the grid.

According to yet further embodiments, the regulation of output voltage of photovoltaic inverting modules 410a-410n is achieved directly by the grid 406. The regulation does not require control unit 418 and switch 414 as shown in FIG. 4a and relies on the fact that grid 406 is almost infinitely greater in terms of potential supply of power by comparison to the AC power produced by photovoltaic inverting modules 410a-410n. The greater power of grid 06 forces photovoltaic inverting modules 410a-410n to adjust to the grid voltage and as such, photovoltaic inverting modules 410a-410n are preferably operated to give as much voltage as possible at their outputs. Typically, photovoltaic inverting modules 410a-410 are capable of sensing grid voltage 406 so as to provide anti-islanding.

The definite articles “a”, “an” is used herein, such as “a photovoltaic panel”, have the meaning of “one or more” that is “one or more photovoltaic panels”.

Although selected embodiments have been shown and described, it is to be appreciated that changes may be made to these embodiments without departing from the principles and spirit of the invention.

1. A system comprising:
a photovoltaic (PV) power source configured to generate a direct current (DC) power;
an inverter configured to receive the DC power via an input terminal of the inverter and configured to convert the DC power to alternating current (AC) power; and
first circuitry configured to transmit a signal to second circuitry,
wherein the second circuitry is configured to control, based on the signal, whether the inverter outputs the AC power.

2. The system of claim 1, further comprising an energy storage device switchably connected to the inverter and configured to receive the AC power while the energy storage device is connected to the inverter.

3. The system of claim 2, wherein the energy storage device comprises:
a battery; and
battery charging circuitry configured to charge the battery from the AC power.

4. The system of claim 1, wherein the signal comprises at least one of the following: a communication signal, a control signal, a synchronization signal, or a keep-alive signal.

5. The system of claim 1, wherein the second circuitry is configured to control, further based on the DC power, whether the inverter outputs the AC power.

6. The system of claim 1, wherein the second circuitry is configured to receive the signal via AC power lines.

7. The system of claim 1, wherein the second circuitry is configured to stop the inverter converting the DC power to the AC power based on the signal not being received for at least a predetermined period of time.

8. The system of claim 1, wherein the first circuitry is further configured to disconnect the inverter from an electrical grid based on a serial voltage, that is based on an output voltage of the inverter, being less than a voltage of the electrical grid.

9. The system of claim 1, wherein the first circuitry is further configured to disconnect the inverter from an electrical grid based on a lack of synchronization existing between a serial voltage, that is based on an output voltage of the inverter, and a voltage of the electrical grid.

10. A method comprising:
receiving by an inverter from a photovoltaic (PV) power source, a direct current (DC) power, wherein the inverter is configured to receive the DC power and to convert the DC power to alternating current (AC) power;
receiving, by control circuitry, a signal; and
causing, using the control circuitry and based on the signal, the inverter to selectively output the AC power.

11. The method of claim 10, further comprising the inverter being switchably connected to an energy storage device, wherein the energy storage device is configured to receive the AC power while the energy storage device is connected to the inverter.

12. The method of claim 11, wherein the energy storage device comprises:
a battery; and
battery charging circuitry configured to charge the battery from the AC power.

13. The method of claim 10, wherein the signal comprises at least one of the following:
a communication signal, a control signal, a synchronization signal, or a keep-alive signal.

14. The method of claim 10, wherein the causing the inverter to selectively output the AC power is based on both the signal and the DC power.

15. The method of claim 10, wherein the receiving the signal comprises receiving the signal via AC power lines.

16. The method of claim 10, wherein the causing the inverter to selectively output the AC power based on the signal comprises causing, by the control circuitry, the inverter to stop converting the DC power to the AC power based on the signal not being received for at least a predetermined period of time.

17. The method of claim 10, further comprising disconnecting, using the control circuitry, the inverter from an electrical grid based on one or both of the following conditions existing:
a serial voltage, that is based on an output voltage of the inverter, being less than a voltage of the electrical grid; or
a lack of synchronization existing between the serial voltage and the voltage of the electrical grid.

18. An inverter comprising:
converter circuitry configured to receive, via an input terminal of the inverter, direct current (DC) power, and to convert the DC power to alternating current (AC) power; and
control circuitry configured to control, based on a signal received by the control circuitry, whether the converter circuitry converts the DC power to the AC power.

19. The inverter of claim 18, further comprising AC outputs that are configured to output the AC power and to connect to an energy storage device.

20. The inverter of claim 18, wherein the control circuitry is configured to control, further based on the DC power, whether the converter circuitry converts the DC power to the AC power.
